(19) United States
(12) Patent Application Publication
(10) Pub. No.: US 2009/0070036 A1
(43) Pub. Date: Mar. 12, 2009

(54) VOICE GUIDE DEVICE, VOICE GUIDE METHOD, VOICE GUIDE PROGRAM, AND RECORDING MEDIUM

(75) Inventors: Kenji Nakamura, Saitama (JP); Koichi Kikuchi, Saitama (JP); Katsunori Oritani, Saitama (JP); Manabu Kiyota, Saitama (JP); Yasuo Ogiwara, Saitama (JP); Kiyoshi Morikawa, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 12/293,169

(22) PCT Filed: Mar. 13, 2007
(86) PCT No.: PCT/JP2007/054880

§ 371 Date: Oct. 14, 2008

(30) Foreign Application Priority Data
Mar. 16, 2006 (JP) 2006-073258

(51) Int. Cl. G01C 21/26

(52) U.S. Cl. 701/211

(57) ABSTRACT

A reception unit (103) receives selection of a guide execution item. Furthermore, the reception unit (103) receives setting of execution information specifying a condition for executing a voice guide for a guide execution item not selected by the reception unit (103). If the guide execution item has been selected, the guide unit (104) executes a voice guide correlated with the guide execution item. Moreover, if the guide execution item has not been selected and if the travel state of a moving body detected by a detection unit (102) satisfies the condition specified by the execution information, the guide unit (104) executes a voice guide correlated with the guide execution item which has not been selected.

### TECHNICAL FIELD

The present invention relates to an audio guidance device, an audio guidance method, an audio guidance program, and a recording medium that provide audio guidance. However, application of the present invention is not limited to the audio guidance device, the audio guidance method, the audio guidance program, and the recording medium.

### BACKGROUND ART

Conventionally, audio guidance devices retrieve an optimal route through the setting of a destination point and execute various kinds of guidance by audio when guidance for the retrieved route is given for a vehicle. Among such audio guidance devices is an audio guidance device that determines a priority level at the time of audio guidance depending on the state of the audio guidance, and based on this determination, further determines the audio level that is to be output and mixes the audio for output from a speaker. With this audio guidance device, by adjusting a mixing state of the volume of the sound device and the volume of the audio guidance depending on importance of the audio guidance to be given, it is possible to clearly indicate the importance of the information to be output from the audio guidance device, and prevent important audio guidance from being missed (for example, see, Patent Document 1 below).

Patent Document 1: Japanese Patent Laid-Open Publication No. 2002-116045

### DISCLOSURE OF INVENTION

### Problem to be Solved by the Invention

However, although the conventional technique described in the above patent document prevents important audio guidance from being missed by determining the priority depending on a state of the audio guidance, there is a problem, for example, in that audio guidance can be annoying for some users even if the audio guidance is important guidance. Furthermore, there is a problem, for example, in that even if the priority can be set by users and the sound level of important audio guidance is adjustable, depending on a traveling state of the vehicle, users may require audio guidance.

### Means for Solving Problem

To solve the problems above and achieve an object, an audio guidance device according to the invention of claim 1 executes various kinds of audio guidance depending on a moving state of a mobile object. The audio guidance device includes a detecting unit that detects the moving state of the mobile object; an receiving unit that receives selection of an arbitrary guidance execution item selected from among a plurality of guidance execution items to execute the various kinds of audio guidance; and a guiding unit that executes audio guidance that is associated with the guidance execution item received by the receiving unit. The receiving unit further receives setting of execution information that specifies a condition for automatically executing, depending on the moving state, audio guidance for a guidance execution item not selected among the guidance execution items. The guiding unit further executes, when the moving state satisfies the condition specified by the execution information, the audio guidance that is associated with the guidance execution item not selected.

An audio guidance method according to the invention of claim 5 is a method of executing various kinds of audio guidance depending on a moving state of a mobile object. The audio guidance method includes a detecting step of detecting the moving state of the mobile object; an receiving step of receiving selection of an arbitrary guidance execution item selected from among a plurality of guidance execution items to execute the various kinds of audio guidance; and a guiding step of executing audio guidance that is associated with the guidance execution item received at the receiving step. The receiving step further includes receiving setting of execution information that specifies a condition for automatically executing, depending on the moving state, audio guidance for a guidance execution item not selected among the guidance execution items. The guiding step further includes executing, when the moving state satisfies the condition specified by the execution information, the audio guidance that is associated with the guidance execution item not selected.

An audio-guidance computer program according to the invention of claim 6 causes a computer to execute the audio guidance method according to claim 5.

A computer-readable recording medium according to the invention of claim 7 stores therein the audio-guidance computer program according to claim 6.

### BRIEF DESCRIPTION OF DRAWINGS

FIG. 1 is a block diagram of a functional configuration of an audio guidance device according to an embodiment;

FIG. 2 is a flowchart showing a procedure of audio guidance performed by the audio guidance device;

FIG. 3 is a block diagram depicting a hardware configuration of a navigation device according to an example; and

FIG. 4 is a flowchart depicting processing of the navigation device.

### EXPLANATIONS OF LETTERS OR NUMERALS

100 Audio guidance device
101 Display unit
102 Detecting unit
103 Receiving unit
104 Guiding unit
105 Audio output unit

### BEST MODE(S) FOR CARRYING OUT THE INVENTION

Exemplary embodiments of an audio guidance device, an audio guidance method, an audio guidance program, and a recording medium according to the present invention are explained in detail below with reference to the accompanying drawings.

### EMBODIMENT

### (Functional Configuration of Audio Guidance Device 100)

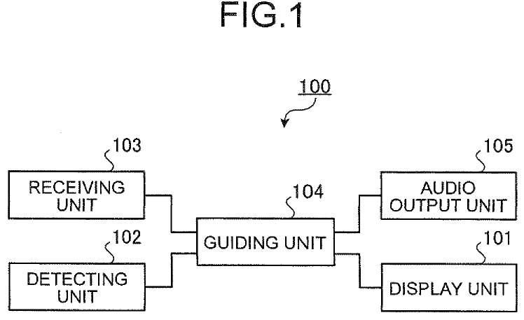

First, a functional configuration of an audio guidance device 100 according to an embodiment of the present invention is explained. FIG. 1 is a block diagram of a functional configuration of the audio guidance device 100 according to the embodiment.

As shown in FIG. 1, the audio guidance device 100 includes a display unit 101, a detecting unit 102, a receiving unit 103, a guiding unit 104, and an audio output unit 105. The display unit 101 includes a display screen on which map data is displayed. The map data is stored in a storage unit not shown. The map data includes road network data that is constituted of nodes and links, and image data that is drawn using a feature of facility, road, and other configurations (mountain, river, land). The map data can include character information, information concerning the name and address of a facility, and road and facility images.

The detecting unit 102 detects a moving state of a mobile object. The moving state is indicated by a current position, a behavior, and the like of the mobile object. The detecting unit 102 detects the moving state according to a value output from an acceleration sensor and a speed sensor to detect the behavior of the mobile object, in addition to a GPS signal from GPS satellites. Moreover, the detecting unit 102 measures the duration of the audio guidance as an execution period. The execution period of the audio guidance is the actual time during which the audio guidance is executed by the guiding unit 104 described later. Furthermore, based on the obtained execution period of the audio guidance, the detecting unit 102 can detect a non-execution period, which is a period of time during which the audio guidance is not executed.

The receiving unit 103 receives selection of an arbitrary guidance execution item selected from among plural guidance execution items. A guidance execution item is, for example, an item that is classified according to the type of audio guidance, is respectively for executing various kinds of audio guidance according to the moving state of the mobile object, and is displayed on the display screen of the display unit 101. The guidance execution item specifically is an item for which audio guidance is given such as audio guidance at the time of route guidance, audio guidance at the time of route change, audio guidance related to information concerning a road ahead on a route, audio guidance related to a prefectural boundary, audio guidance reminding the user to take a rest, and the like.

Furthermore, the receiving unit 103 receives selected execution information for the guidance execution items not selected. The execution information is, for example, information that specifies a condition for the automatic execution of audio guidance depending on the moving state detected by the detecting unit 102. The execution information specifically is information indicative of time, such as when audio guidance has not been given for a predetermined period or longer, and information concerning a position of the mobile object when the mobile object successively reaches intersections at which the mobile object turns right or left or deviates from a route. Further, the receiving unit 103 is implemented by a touch panel that is superimposed on a display screen of the display unit 101, by a mouse or a remote controller to control a cursor on the display screen, and the like.

The guiding unit 104 executes audio guidance that is associated with the arbitrary guidance execution item received by the receiving unit 103. Moreover, the guiding unit 104 also executes audio guidance that is associated with the guidance execution item not selected when the moving state of the mobile object detected by the detecting unit 102 satisfies the condition that is specified by the execution information received by the receiving unit 103. Furthermore, the guiding unit 104 outputs an alarm to encourage the determination whether to execute audio guidance when the non-execution period detected by the detecting unit 102 is at least equal to the predetermined period. The alarm is, for example, an alarm sound or a message encouraging a user to determine whether to execute audio guidance. Further, as for the guidance execution item not selected, the guiding unit 104 can control the display unit 101 to not perform display relating to route guidance on the map data on the display screen.

The audio output unit 105 includes a speaker or the like and outputs an audio signal for the audio guidance that is associated with the arbitrary guidance execution item. Alternatively, the audio output unit 105 can output an audio signal from an audio device not shown. Further, the audio signal for audio guidance can be output by a different control.

### (Procedure of Audio Guidance Performed by Audio Guidance Device 100)

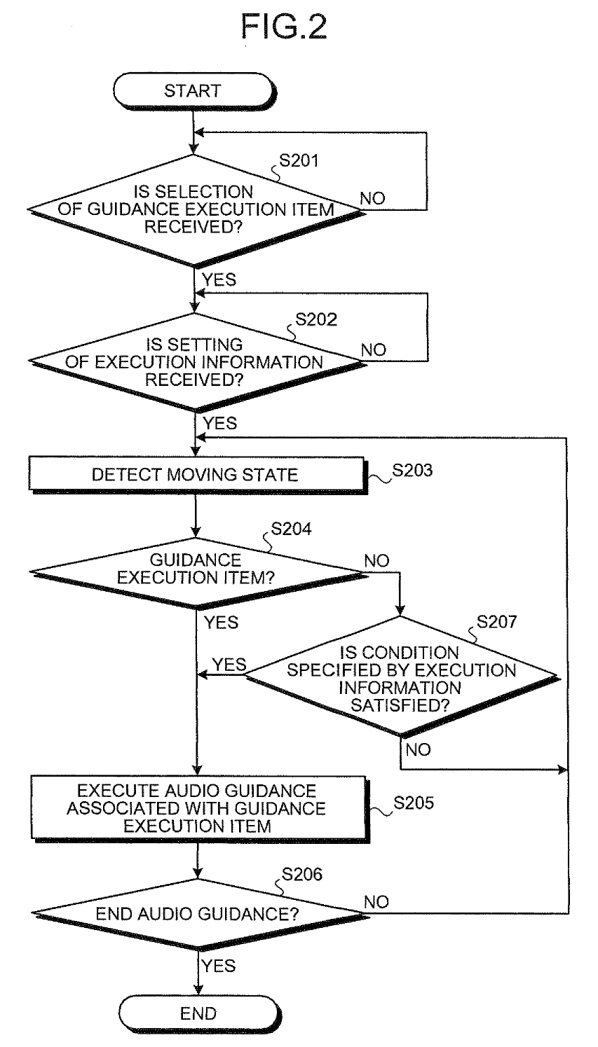

Next, a procedure of audio guidance performed by the audio guidance device 100 is explained. FIG. 2 is a flowchart showing the procedure of audio guidance performed by the audio guidance device 100. As shown in the flowchart in FIG. 2, first, waiting occurs until the receiving unit 103 receives selection of a guidance execution item (step S201: loop of NO), and when the selection is received (step S201: YES), waiting further occurs until the receiving unit 103 receives the setting of the execution information for a guidance execution item not selected (step S202: loop of NO).

When the selection of the execution information is received at step S202 (step S202: YES), the detecting unit 102 detects the moving state of the mobile object (step S203), and determines whether the moving state is a guidance execution item (step 3204). When the moving state is a guidance execution item (step S204: YES), audio guidance that is associated with the guidance execution item determined at step S204 is executed (step S205). It is then determined whether to end the audio guidance (step 3206). When the audio guidance is to be ended (step S206: YES), a series of processing is ended.

On the other hand, when the moving state is not a guidance execution item (step S204: NO), it is determined whether the moving state of the mobile object detected by the detecting unit 102 satisfies the condition specified by the execution information (step S207). When the condition specified by the execution information is determined to be satisfied at step S207 (step S207: YES), the process proceeds to step S205, and audio guidance that is associated with an audio execution item not selected and is indicated by the execution information that has been set, is executed.

On the other hand, when the condition specified by the execution information is determined not to be satisfied at step S207 (step S207: NO), or when the audio guidance is not to be ended (step S206: NO), the process returns to step S203, and processing thereafter is repeated.

Although in FIG. 2, it is explained that waiting occurs until the selection of a guidance execution item is received at step S201, configuration is not limited thereto. For example, configuration can be such that when no selection of a guidance execution item is received for a predetermined period or longer, selection of all guidance execution items or predetermined selection is received.

Furthermore, although in FIG. 2, it is explained that waiting occurs until a setting of the execution information is received at step 3202, configuration is not limited thereto. For example, configuration can be such that when no setting is received for a predetermined period or longer, all settings of execution information or a predetermined setting is received.

Moreover, although in FIG. 2, it is explained that the moving state is detected at step S203, configuration is not limited thereto. For example, configuration can be such that the moving state of the mobile object is continuously detected before receiving the selection of a guidance execution item at step S201, or the moving state of the mobile object is detected only for a guidance execution item not selected at step S201.

Furthermore, although in FIG. 2, it is explained that a series of processing is ended when the audio guidance is determined to be ended at step S206: YES, configuration is not limited thereto. For example, when a destination point is set in advance, configuration can be such that when the destination point is reached, a series of processing is ended.

As described, with the audio guidance device 100 according to the embodiment, it is possible to execute, by the guiding unit 104, audio guidance that is associated with a guidance execution item for which selection is received by the receiving unit 103. Moreover, also for the guidance execution item not selected, if the execution information is set, audio guidance can be executed automatically depending on the moving state of the mobile object.

Therefore, it is possible to execute, among various kinds of audio guidance, only the audio guidance that is desired by a user. In addition, audio guidance that is not desired by the user can be executed automatically depending on the moving state of the mobile object. This enables a user to set, among various kinds of audio guidance, annoying audio guidance exclusive of desired audio guidance, to not be executed and yet depending on the moving state of the mobile object, audio guidance other than the desired audio guidance can be automatically executed.

Moreover, with the audio guidance device 100 according to the embodiment, audio guidance can be such that the audio guidance is executed automatically when the detecting unit 102 detects that the mobile object has reached in succession an intersection at which a right or left turn is to be made. This enables a user to receive the audio guidance automatically at the intersection at which right or left turn is to be made even when audio guidance of route guidance is not being executed, for example.

Furthermore, with the audio guidance device 100 according to the embodiment, audio guidance can be set to be executed automatically when the detecting unit 102 detects that the mobile object has deviated from a route being guided. This enables a user to receive automatically guidance by audio guidance for rerouting even when audio guidance for route guidance is not being executed, for example.

Moreover, with the audio guidance device 100 according to the embodiment, the execution period of audio guidance can be measured by the detecting unit 102. Further, audio guidance can be automatically executed when the non-execution period of audio guidance based on the obtained execution period is at least equal to a predetermined period. This enables a user to confirm, at predetermined period intervals, whether a guidance execution item is selected.

### EXAMPLE

Examples of the present invention are explained below.

In a present example, one example in a case where the audio guidance device of the present invention is implemented by a navigation device that is mounted on the mobile object such as a vehicle (including four-wheel vehicle and two-wheel vehicle) is explained.

### (Hardware Configuration of Navigation Device 300 According to Example)

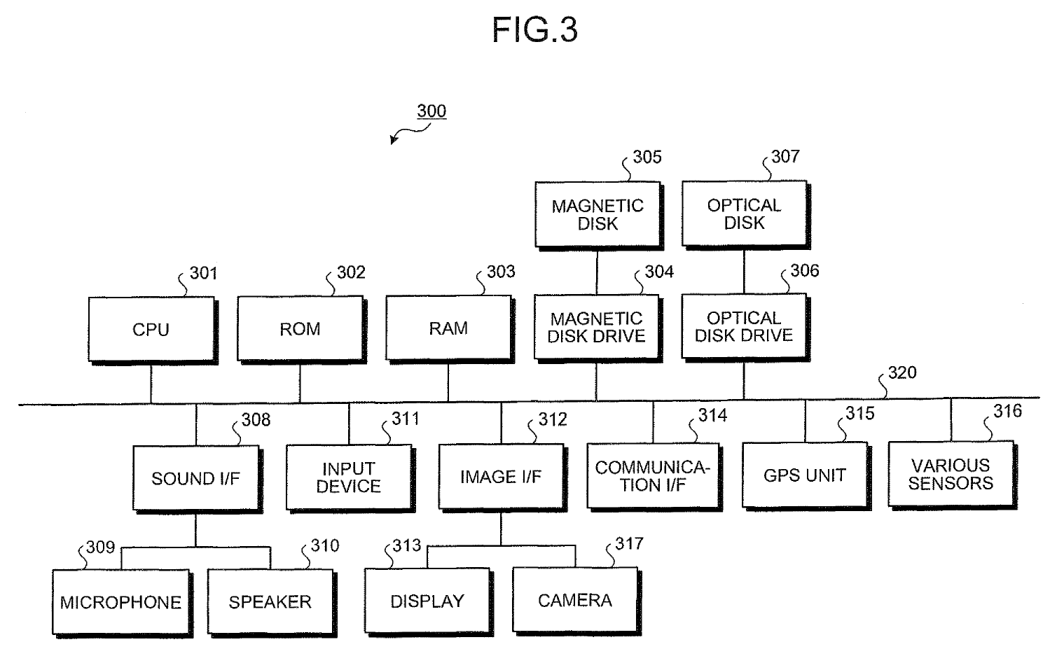

A hardware configuration of a navigation device 300 according to the example is explained. FIG. 3 is a block diagram depicting the hardware configuration of the navigation device according to the example. As shown in FIG. 3, the navigation device 300 includes a CPU 301, a ROM 302, a RAM 303, a magnetic disk drive 304, a magnetic disk 305, an optical disk drive 306, an optical disk 307, a sound I/F (interface) 308, a microphone 309, a speaker 310, an input device 311, an image I/F 312, a display 313, a communication I/F 314, a GPS unit 315, various sensors 316, and a camera 317. The respective components 301 to 317 are connected through a bus 320.

Firstly, the CPU 301 controls the entire navigation device 300. The ROM 302 stores a program such as a boot program and a data update program. Moreover, the RAM 303 is used as a work area of the CPU 301. In other words, the CPU 301 controls the entire navigation device 300 by executing various programs recorded on the ROM 302 while using the RAM 303 as a work area.

The magnetic disk drive 304 controls the reading/writing of data with respect to the magnetic disk 305 under the control of the CPU 301. The magnetic disk 305 records data that is written under the control of the magnetic disk drive 304. As the magnetic disk 305, for example, an HD (hard disk) and an FD (flexible disk) can be used.

Further, the optical disk drive 306 controls the reading/writing of data with respect to the optical disk 307 under the control of the CPU 301. The optical disk 307 is a detachable recording medium from which data is read under the control of the optical disk drive 306. For the optical disk 307, a writable recording medium can be used. As a detachable recording medium, an MO, a memory card, or the like can be used other than the optical disk 307.

Map data and function data are examples of information to be recorded on the magnetic disk 305 or the optical disk 307. The map data includes background data indicative of buildings, rivers, ground surfaces, and the like (features) and road configuration data indicative of shapes of roads, and is configured with plural data files that are classified into areas.

The road data further includes traffic condition data. The traffic condition data includes information concerning presence of signals and crossroads, presence of entrance and exit or junction of expressways, length (distance) of each link, road width, traveling direction, types of road (expressway, toll road, local road, etc.).

The function data includes three-dimensional data expressing the shape of a facility on a map, character data concerning an explanation of the facility, and various kinds of data other than the map data. The map data and the function data are recorded being classified into blocks according to areas and functions. Specifically, for example, the map data can be classified into blocks for respective areas so that each represents a predetermined area on a displayed map. For example, the function data can be classified into blocks according to functions so that each implements one function.

In addition to the three-dimensional data and the character data described above, the function data includes data to implement a function such as route search, calculation of required time, program data to perform route guidance. The map data and the function data are configured with a plurality of data files that are separated according to areas and functions.

The sound I/F 308 is connected to the microphone 309 for audio input and the speaker 310 for audio output. Sound received by the microphone 309 is subjected to A/D conversion in the sound I/F 308. The microphone 309 is arranged, for example, near a sun visor of a vehicle, and the number thereof to be arranged can be single or plural. From the speaker 310, sound that is obtained by performing D/A conversion on a given audio signal in the sound I/F 308 is output. The sound input through the microphone 309 can be recorded on the magnetic disk 305 or the optical disk 307 as sound data.

The input device 311 includes a remote, a keyboard, and a touch panel that have plural keys to input characters, numerals, various instructions, and the like. The input device 311 can be implemented by one form or more than one form among the remote, the keyboard, and the touch panel.

The image I/F 312 is connected to the display 313. Specifically, the image I/F 312 is configured with, for example, a graphic controller that controls the entire display device, a buffer memory such as VRAM (video RAM) that temporarily stores image data that can be displayed immediately, a control IC that controls the display device 313 based on the image data output by the graphic controller, and the like.

On the display 313, an icon, a cursor, a menu, a window, or various kinds of data such as characters and images is displayed. The map data described above is drawn two-dimensionally or three-dimensionally on the display 313. On the map displayed on the display 313, a mark expressing a current position of a vehicle on which the navigation device 100 is mounted can be superimposed to be displayed. The current position of a vehicle is calculated by the CPU 301.

As the display 313, for example, a CRT, a TFT liquid crystal display, a plasma display, and the like can be used. The display 313 is arranged, for example, near a dashboard of a vehicle. More than one display 313 can be arranged in a vehicle by arranging one near a rear seat of the vehicle in addition to near the dashboard of the vehicle.

The communication I/F 314 is connected to a network through wireless communication, and functions as an interface between the navigation device 300 and the CPU 301. The communication I/F 314 is further connected to a communication network such as the Internet through a wireless communication, and functions as an interface between this network and the CPU 301 also.

The communication network includes a LAN, a WAN, a public line network, and a mobile telephone network. Specifically, the communication I/F 314 is configured with an FM tuner, a VICS (vehicle information and communication system)/beacon receiver, a wireless navigation device, and other navigation devices, and obtains road traffic information concerning traffic congestion and road restrictions distributed from the VICS center. VICS is a registered trademark.

The GPS unit 315 receives signals from GPS satellites, and outputs information indicating a current position of a vehicle. The output data from the GPS unit 315 is used at the time of calculation of a current position of a vehicle together with output values of the various sensors 316 described later. The information indicating a current position is information to identify one point on the map data, such as longitude, latitude, and altitude.

The various sensors 316 output information concerning the moving state to determine a position and a behavior of a vehicle, such as information from a speed sensor, an acceleration sensor, an angular speed sensor, and the like.

The values output from the various sensors 316 are used for the calculation of a current position of a vehicle by the CPU 301 and calculation of an amount of change in speed or orientation.

The camera 317 captures an image of the interior or the exterior of the vehicle. The image can be a still image or a moving image, and a behavior of a passenger inside the vehicle, for example. The obtained image is output to a recording medium, such as the magnetic disk 305 or the optical disk 307, through the image I/F 312. The camera 317 further captures images of a state outside the vehicle, and the obtained image is output to a recording medium, such as the magnetic disk 305 or the optical disk 307, through the image I/F 312. Moreover, the camera 317 has an infrared ray camera function, and based on image data that is obtained using the infrared ray camera function, the distribution of surface temperature of objects present inside the vehicle can be relatively compared. For the image output to the recording medium, overwrite and saving are executed.

Functions of the display unit 101, the detecting unit 102, the receiving unit 103, the guiding unit 104, and the audio output unit 105 included in the audio guidance device shown in FIG. 1 are implemented using a program or data recorded on the ROM 302, the RAM 303, the magnetic disk 305, the optical disk 307, and the like in the navigation device 300 shown in FIG. 3, by the CPU 301 executing a predetermined program to control respective components in the navigation device 300.

In other words, the navigation device 300 according to the example can implement the functions of the audio guidance device shown in FIG. 1 in the procedure of the audio guidance shown in FIG. 2 by executing an audio guidance program recorded on the ROM 302 as the recording medium in the navigation device 300.

### (Processing Performed by Navigation Device 300)

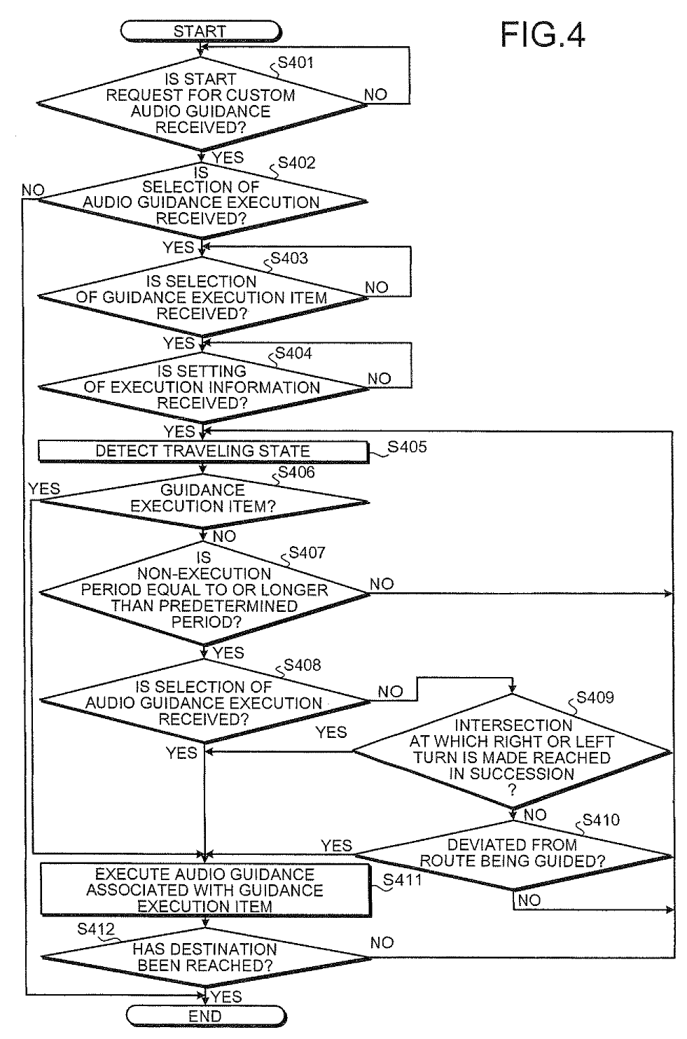

Next, processing performed by the navigation device 300 is explained. FIG. 4 is a flowchart depicting the processing of the navigation device. As shown in the flowchart in FIG. 4, first, waiting occurs until a start request of custom audio guidance is received (step S401: loop of NO), and when the start request for the custom audio guidance is received (step S401: YES), whether selection for audio guidance execution is received is determined (step S402). At step S402, the selection of the audio guidance execution is selection of whether to execute guidance for all of the various kinds of audio guidance depending on the moving state of a mobile object.

When the selection of the audio guidance execution is received (step S402: YES), waiting occurs until selection of a guidance execution item is received (step S403: loop of NO). When the selection of a guidance execution item is received (step S403: YES), waiting occurs until setting of the execution information for a guidance execution item not selected at step S403 is received (step S404: loop of NO). At step S403, whether selection of a guidance execution item has been made is determined, for example, by displaying respective guidance execution items on the display screen of the display 313 and by letting a user select with a touch panel or the like. At step S404, the execution information is information indicating the execution of audio guidance when the non-execution period of audio guidance is at least equal to a predetermined period, when intersections at which a right or left turn is made are reached successively, and when deviation from the route being guided occurs.

When the setting of execution information is received at step S404 (step S404: YES), the setting of the custom audio guidance is ended, and the traveling state of the vehicle is detected (step S405) and whether the traveling state is a guidance execution item is determined (step S406). When the traveling state is not a guidance execution item (step S406: NO), it is determined whether the non-execution period of audio guidance is at least equal to the predetermined period (step S407). When the non-execution period is at least equal to the predetermined period (step S407: YES), an alarm to encourage determination whether to execute audio guidance is output, and whether selection of audio guidance execution by the user is received is determined (step S408).

The determination whether the selection of audio guidance execution is received at step S408 is made, for example, by displaying a key to receive the decision of the user and by determining whether the key is selected, in addition to outputting the alarm to encourage the determination whether to execute audio guidance. Thus, whether the selection of audio guidance execution is received is determined. When the selection of audio guidance execution is not received (step S408: NO), it is determined whether the vehicle has reached in succession an intersection at which a right or left turn is made (step 5409). When an intersection at which a right or left turn is made is not reached in succession (step S409: NO), it is determined whether the vehicle has deviated from the route being guided (step S410).

When the traveling state is determined as the guidance execution item at step S406 (step S406: YES), when it is determined that the selection of audio guidance execution is received at step S408 (step S408: YES), when it is determined at step S409 that the vehicle has reached a successive intersection at which a right or left turn is made (step S409: YES), and when it is determined that the vehicle has deviated from the route being guided (step S410: YES), audio guidance that is associated with each of the guidance execution items is executed (step S411). Subsequently, it is determined whether the destination point has been reached (step S412), and when the destination point has been reached (step S412: YES), a series of processing is ended.

On the other hand, when the non-execution period is determined to not be at least equal to the predetermined period at step S407 (step S407: NO), when it is determined that the vehicle has not deviated from the route being guided (step S410: NO), and when it is determined that the destination point has not been reached at step S412 (step S412: NO), the process returns to step S405, and processing thereafter is repeated. Moreover, when it is determined that the selection of audio guidance execution is not received (step S402: NO), a series of processing is ended.

Although in the explanation of FIG. 4, it is determined whether the selection of audio guidance execution is received at step S402, configuration is not limited thereto. For example, it can be determined that the selection of audio guidance execution is not received when it is determined that no selection of any guidance execution item is received at step S403.

Furthermore, the determination whether the non-execution period is at least equal to the predetermined period at step S407, the determination whether the vehicle has reached in succession an intersection at which the a right or left turn is made at step S409, and the determination whether the vehicle has deviated from the route being guided at step S410 in the explanation in FIG. 4 can be made simultaneously or made in a different sequence.

Moreover, although in the explanation of FIG. 4, a series of processing is ended when it is determined that the destination point has been reached at step S412: YES, configuration is not limited thereto. For example, when a destination point is not set in advance, configuration can be such that a series of processing is ended when the power of the navigation device 300 is turned OFF.

As described above, according to the navigation device 300 of the example, audio guidance that is associated with a guidance execution item for which selection is received by the receiving unit 103 can be executed by the guiding unit 104. In addition, for a guidance execution item not selected, by setting the execution information, audio guidance can be automatically executed depending on the moving state of a mobile object.

Therefore, among various kinds of audio guidance, it is possible to execute only audio guidance desired by a user and further, even for a guidance execution item not selected, it is possible to execute audio guidance automatically depending on the moving state of a mobile object. Thus, the user can set the device such that annoying audio guidance other than desired audio guidance among various kinds of audio guidance is not executed, and depending on the moving state of the mobile object, audio guidance other than the desired audio guidance can also be executed automatically.

Moreover, according to the navigation device 300 of the example, a setting is enabled such that when the detecting unit 102 detects that a successive intersection at which the mobile object makes a right or left turn is reached, audio guidance is automatically executed. Thus, the user can receive guidance by audio guidance automatically upon successively reaching an intersection at which a right or left turn is to be made, even if audio guidance of route guidance is not being executed.

Furthermore, according to the navigation device 300 of the example, a setting is enabled such that when the detecting unit 102 detects that the mobile object has deviated from a route being guided, audio guidance is automatically executed. Thus, the user can receive guidance by audio guidance automatically even if audio guidance of route guidance is not being executed.

Moreover, according to the navigation device 300 of the example, it is possible to measure an execution period of audio guidance by the detecting unit 102. Further, when a non-execution period of audio guidance is determined to be at least equal to a predetermined period based on the measured execution period, audio guidance can be automatically executed. Thus, the user can confirm whether a guidance execution item is selected at predetermined period intervals.

As described above, with the audio guidance device 100, the audio guidance method, the audio guidance program, and the recording medium according to the embodiment, audio guidance can be executed that is associated with a guidance execution item for which selection is received in the navigation device 300. Furthermore, even for a guidance execution item not selected, by setting the execution information, audio guidance can be automatically executed depending on the moving state of the mobile object. Thus, the user can execute a setting such that annoying audio guidance other than desired audio guidance among various kinds of audio guidance is not executed, and depending on the moving state of the mobile object, audio guidance other than the desired audio guidance can also be executed automatically.

The audio guidance method explained in the present embodiment can be implemented using a computer such as a personal computer and a work station, to execute a program that is prepared in advance. This program is recorded on a computer-readable recording medium such as a hard disk, a flexible disk, a CD-ROM, an MO, and a DVD, and is executed by a computer reading it from the recording medium. Moreover, this program can be a transmission medium that can be distributed through a network such as the Internet.

1-7. (canceled)

8. An audio guidance device that executes various kinds of audio guidance depending on a moving state of a mobile object, the audio guidance device comprising:
a detecting unit that detects the moving state of the mobile object;
an receiving unit that receives selection of a guidance execution item selected from among a plurality of guidance execution items for executing the various kinds of audio guidance; and
a guiding unit that executes audio guidance that is associated with the guidance execution item received by the receiving unit, wherein
the receiving unit further receives setting of execution information that specifies a condition for automatically executing, depending on the moving state, audio guidance for a guidance execution item not selected and among the guidance execution items, and
the guiding unit further executes, when the moving state satisfies the condition, the audio guidance that is associated with the guidance execution item not selected.

9. The audio guidance device according to claim 8, wherein
the execution information is set such that the condition is that the mobile object reaches in succession an intersection at which the mobile object turns right or left.

10. The audio guidance device according to claim 8, wherein
the execution information is set such that the condition is that the detecting unit detects that the mobile object has deviated from a route being guided.

11. The audio guidance device according to claim 8, wherein
the detecting unit measures an execution period of the audio guidance that is executed by the guiding unit, and
the guiding unit, when a non-execution period of the audio guidance is determined to be at least equal to a predetermined period based on the timed execution period, outputs an alarm to encourage determination whether to execute the audio guidance.

12. An audio guidance method of executing various kinds of audio guidance depending on a moving state of a mobile object, the audio guidance device comprising:
detecting the moving state of the mobile object;
receiving selection of a guidance execution item selected from among a plurality of guidance execution items for executing the various kinds of audio guidance; and
executing audio guidance that is associated with the guidance execution item received at the receiving, wherein
the receiving further includes receiving setting of execution information that specifies a condition for automatically executing, depending on the moving state, audio guidance for a guidance execution item not selected and among the guidance execution items, and
the executing further includes executing, when the moving state satisfies the condition, the audio guidance that is associated with the guidance execution item not selected.

13. A computer-readable recording medium storing therein an audio-guidance computer program that causes a computer to execute:
detecting the moving state of the mobile object;
receiving selection of a guidance execution item selected from among a plurality of guidance execution items for executing the various kinds of audio guidance; and
executing audio guidance that is associated with the guidance execution item received at the receiving, wherein
the receiving includes receiving setting of execution information that specifies a condition for automatically executing, depending on the moving state, audio guidance for a guidance execution item not selected and among the guidance execution items, and
the executing includes executing, when the moving state satisfies the condition, the audio guidance that is associated with the guidance execution item not selected.
